(19) United States
(12) Patent Application Publication
(10) Pub. No.: US 2013/0337345 A1
(43) Pub. Date: Dec. 19, 2013

(54) OXIDE ANODE MATERIALS FOR LITHIUM BATTERIES

(71) Applicants: Ali Abouimrane, Aurora, IL (US); Khalil Amine, Oak Brook, IL (US)

(72) Inventors: Ali Abouimrane, Aurora, IL (US); Khalil Amine, Oak Brook, IL (US)

(21) Appl. No.: 13/524,096

(22) Filed: Jun. 15, 2012

(51) Int. Cl. H01M 4/485; H01M 4/525; H01M 10/056; H01M 4/54

(52) U.S. Cl. 429/338; 429/223; 429/219; 429/220; 429/221; 429/344; 429/341; 429/342; 429/337; 429/199; 429/188; 429/200

(57) ABSTRACT

An electrochemical device includes an electrolyte; a cathode; and an anode including a negative active material of Formula LiₓNi_{α}Mn_{β}Co_{γ}M¹_{δ}M²ₘO_{2-z}M³_{z′}; where M¹ is Mg, Zn, Al, Ga, B, Zr, Ti, V, Cr Ag, Cu, Na, Mn, Fe, Cu, or Zr; M² is P, S, Si, W, or Mo; M³ is F, Cl and N; 0<x; 0≦α≦1; 0≦β≦1; 0≦γ≦1; 0≦δ≦1; 0≦m≦0.5; 0≦z≦0.5; and 0≦z′≦0.5, where at least one of α, β, and γ is greater than 0.

### GOVERNMENT RIGHTS

The United States Government has rights in this invention pursuant to Contract No. DE-AC02-06CH11357 between the United States Government and UChicago Argonne, LLC, representing Argonne National Laboratory.

### FIELD

Generally, the present invention relates to anodic materials for lithium-ion batteries.

### BACKGROUND

In an effort to achieve high voltages and energy densities for energy storage system, R&D research has been extensively conducted on lithium batteries. Indeed, conventional Li-ion batteries using graphite anodes have shown significant improvement in performance, reliability and safety. This has created opportunities for new applications such as in electric and hybrid vehicles. In such applications, the large-sized devices require larger electrode capacity and better durability. Increasing the capacity of the anode material could be very effective in increasing the specific energy of Li-ion batteries. In order to increase the battery energy density, the lithium insertion in metals, intermetallic was deeply studied [A. D. W. Todd et al. J. Electrochem. Soc. 153 (10), A1998-A2005 (2006); A. D. W. Todd et al. J. Elecrochem. Soc. 154 (6), A597-A604 (2007).]. However materials that can alloy with lithium such as Si, Si Ge, Al did not insert lithium reversibly. Furthermore, a huge volume expansion was observed with the alloying-dealloying process which result in active material particles isolation and battery fade.

In order to overcome this problem, the use of oxide materials was proposed because these materials can provide a high tap density. Transition metal oxides have attracted great attention as anode materials for lithium ion batteries, due to their high theoretical capacity, safety, low cost, and natural abundance. However, there are still many challenges in using them as anode materials for lithium ion batteries. One of these challenges is the poor cycling performance, resulting from large volume expansion during the charge-discharge process due to the generation of Li₂O. Furthermore, good cycleability was achieved only for nano-sized materials. Nano materials are not suitable for industrial applications as their volumetric density is very low.

### SUMMARY

In one aspect, an electrochemical device includes an electrolyte; a cathode; and an anode, the anode including a negative active material of Formula LiₓNi_{α}Mn_{β}Co_{γ}M¹_{δ}M²ₘO_{2-z}M³_{z′}. In the electrochemical device, M¹ is Mg, Zn, Al, Ga, B, Zr, Ti, V, Cr Ag, Cu, Na, Mn, Fe, Cu, or Zr; M² is P, S, Si, W, or Mo; M³ is F, Cl and N; 0<x; 0≦α≦1; 0≦β≦1; 0≦γ≦1; 0≦δ≦1; 0≦m≦0.5; 0≦z≦0.5; and 0≦z′≦0.5; with the proviso that at least one of α, β, and γ is greater than 0. In some embodiments, x is 0.5 or 1; m=0; z′=0; M¹ is B, Al, or Ga; and 0≦δ≦0.25. In some embodiments, the negative active material is LiMn_{0.5}O_{1.5}, LiNiO₂, LiCoO₂, LiNi_{1/3}Co_{1/3}Mn_{1/3}O₂, LiNi_{0.8}Co_{0.05}Al_{0.15}O₂, or Li_{0.5}Ni_{0.25}Mn_{0.75}O₂. In other embodiments, the anodic material is a compound of Formula Li_{1+x′}Ni_{y′}Mn_{z″}Co_{1-z″}O₂; 0≦x′; 0≦y′; and 0≦z″.

In some embodiments, the cathode of the device includes a positive active material that is a spinel, a olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, L_{1+x″}Ni_{α}Mn_{β}Co_{γ}M⁵_{δ′}O_{2-z″}F_{z″}, A_{n′}B¹₂(M²O₄)₃, or VO₂. In the positive active materials, M⁴ is Al, Mg, Ti, B, Ga, Si, Mn, or Co; M⁵ is Mg, Zn, Al, Ga, B, Zr, or Ti; A is Li, Ag, Cu, Na, Mn, Fe, Co, Ni, Cu, or Zn; B¹ is Ti, V, Cr, Fe, or Zr; 0≦x≦0.3; 0≦y≦0.5; 0≦z≦0.5; 0≦m≦0.5; 0≦n≦0.5; 0≦x″≦0.4; 0≦α≦1; 0≦β≦1; 0≦γ≦1; 0≦δ′≦0.4; 0≦z″≦0.4; and 0≦n′≦3; with the proviso that at least one of α, β and γ is greater than 0. In some embodiments, the cathode includes a blend of a spinel and a positive active material of Formula Li_{1+x″}Ni_{α}Mn_{β}Co_{γ}M⁵_{δ′}O_{2-z″}F_{z″}; M⁵ is Mg, Zn, Al, Ga, B, Zr, or Ti; 0≦x″≦0.4; 0≦α≦1; 0≦β≦1; 0≦γ≦1; 0≦δ′≦0.4; and 0≦z″≦0.4. The ratio of spinel to Li_{1+x″}Ni_{α}Mn_{β}Co_{γ}M⁵_{δ′}O_{2-z″}F_{z″} may be from about 0.5 wt % to about 98 wt %. In other embodiments, the cathode includes a blend of a olivine or a carbon-coated olivine and Li_{1+x″}Ni_{α}Mn_{β}Co_{γ}M⁵_{δ′}O_{2-z″}F_{z″}; M⁵ is Mg, Zn, Al, Ga, B, Zr, or Ti; 0≦x″≦0.4; 0≦α≦1; 0≦β≦1; 0≦γ≦1; 0≦δ′≦0.4; and 0≦z″≦0.4. The ratio of the olivine or carbon-coated olivine to Li_{1+x″}Ni_{α}Mn_{β}Co_{γ}M⁵_{δ′}O_{2-z″}F_{z″}, may be from about 0.5 wt % to about 98 wt %.

### BRIEF DESCRIPTION OF THE DRAWINGS

FIG. 1 is a graph of charge and discharge voltage profiles for a Li_{1.2}Ni_{0.3}Mn_{0.6}O₂/Li half-cell, according to the examples.

FIG. 2 is a graph of charge and discharge capacities vs. cycle number for a Li_{1.2}Ni_{0.3}Mn_{0.6}O₂/Li half-cell, according to the examples.

FIG. 3 is a graph of charge and discharge voltage profiles for a LiNi_{1/3}Co_{1/3}Mn_{1/3}O₂/Li half-cell, according to the examples.

FIG. 4 is a graph of charge and discharge capacities vs. cycle number for a LiNi_{1/3}Co_{1/3}Mn_{1/3}O₂/Li half-cell, according to the examples.

FIG. 5 is a graph of charge and discharge voltage profiles for a LiNi_{0.8}Co_{0.15}Al_{0.05}O₂/Li half-cell, according to the examples.

FIG. 6 is a graph of charge and discharge capacities vs. cycle number for a LiNi_{0.8}Co_{0.15}Al_{0.05}O₂/Li half-cell, according to the examples.

FIG. 7 is a differential scanning calorimeter graph of graphite and Li_{1.2}Ni_{0.3}Mn_{0.6}O₂, according to the examples.

### DETAILED DESCRIPTION

For the purposes of this disclosure and unless otherwise specified, “a” or “an” means “one or more.”

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, the term “gelled electrolyte” refers to the incorporation of polymerizable materials that will form a gel, thus providing viscosity and body to the electrolyte, while still allowing for ion transport within the electrolyte.

Alkyl groups include straight chain and branched alkyl groups having from 1 to 12 carbon atoms or, in some embodiments, from 1 to 8, 1 to 6, or 1 to 4 carbon atoms. Alkyl groups further include cycloalkyl groups as defined below. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Cycloalkyl groups further include mono-, bicyclic and polycyclic ring systems. Substituted cycloalkyl groups may be substituted one or more times with non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4- 2,5- or 2,6-disubstituted cyclohexyl groups, which may be substituted with substituents such as those listed above.

Alkenyl groups include straight and branched chain and cycloalkyl groups as defined above, except that at least one double bond exists between two carbon atoms. Thus, alkenyl groups have from 2 to about 12 carbon atoms in some embodiments, from 2 to 10 carbon atoms in other embodiments, and from 2 to 8 carbon atoms in other embodiments. Examples include, but are not limited to vinyl, allyl,

—CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above.

Alkynyl groups include straight and branched chain alkyl groups, except that at least one triple bond exists between two carbon atoms. Thus, alkynyl groups have from 2 to about 20 carbon atoms, and typically from 2 to 12 carbons or, in some embodiments, from 2 to 8, 2 to 6, or 2 to 4 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃), among others. Representative substituted alkynyl groups may be mono-substituted or substituted more than once, such as, but not limited to, mono-, di- or tri-substituted with substituents such as those listed above.

Aryl groups are cyclic aromatic hydrocarbons of 6 to 14 carbons that do not contain heteroatoms. Aryl groups herein include monocyclic, bicyclic and tricyclic ring systems. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain from 6 to 12 or even 6 to 10 carbon atoms in the ring portions of the groups. In some embodiments, the aryl groups are phenyl or naphthyl. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halogen groups, bonded to one of the ring members. Rather, groups such as tolyl are referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

Alkoxy groups are hydroxyl groups (—OH) in which the bond to the hydrogen atom is replaced by a bond to a carbon atom of an alkyl group as defined above. Examples of linear alkoxy groups include but are not limited to methoxy, ethoxy, propoxy, butoxy, pentoxy, hexoxy, and the like. Examples of branched alkoxy groups include but are not limited to isopropoxy, sec-butoxy, tert-butoxy, isopentoxy, isohexoxy, and the like. Representative substituted alkoxy groups may be substituted one or more times with substituents such as those listed above. Aryloxy groups are hydroxyl groups (—OH) in which the bond to the hydrogen atom is replaced by a bond to a carbon atom of an aryl group as defined above.

Haloalkyl groups are alkyl groups in which one or more hydrogen atoms on the alkyl group has been replaced by a halogen atom. Haloaryl groups are aryl groups in which one or more hydrogen atoms on the aryl group has been replaced by a halogen atom.

In general, “substituted” refers to an alkyl or alkenyl group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

It has now been determined that transition lithium metal oxides can reversibly insert lithium at low voltage, and therefore can be used as anodic materials. Accordingly, in one aspect, anode materials for lithium rechargeable batteries are provided, the material being based upon lithium metal oxides. The use of such materials as anodic materials, instead of graphite, increases the energy density of the batteries that incorporate these materials. The increase in energy density is due to their high capacity and tap density in comparison to that which may be achieved with conventional graphite anode materials. Moreover, in a full cell configuration, graphite allows for the migration of transition metal ions from the cathode to the anode. The use of the such anodic materials based upon lithium metal oxides, mitigates this problem, as the transition metal ion migration does not affect the cycling ability of the anode, but rather it contributes to the anodic capacity. The transition metal ions are also active in the anode. In terms of battery cost, the use of transition metal oxides both in the anode and the cathode has the ability to reduce battery manufacturing steps and remove a possible bottleneck effect when dealing with more than one material.

Illustrative lithium oxides that may be used as anodic materials include those of formula LiₓNi_{α}Mn_{β}Co_{γ}M¹_{δ}M²ₘO_{2-z}M³_{z′}, where M¹ is Mg, Zn, Al, Ga, B, Zr, Ti, V, Cr Ag, Cu, Na, Fe, Cu, or Zr; M² is P, S, Si, W, or Mo; M³ is F, Cl or N; 0<x; 0≦α≦1; 0≦β≦1; 0≦γ≦1; 0≦δ≦1; 0≦m≦0.5; 0≦z≦0.5; and 0≦z′≦0.5. In the LiₓNi_{α}Mn_{β}Co_{γ}M¹_{δ}M²ₘO_{2-z}M³_{z′}, at least one of α, β, γ is greater than 0. In some embodiments, 0<x<3. In other embodiment, 0<x<1.5. In some embodiments, x is 0.5 or 1; m=0; z′=0; M¹ is B, Al, or Ga; and 0≦δ0.25. The anodic material may include a mixture of any two or more lithium metal oxides of formula LiₓNi_{α}Mn_{β}Co_{γ}M¹_{δ}M²ₘO_{2-z}M³_{z′}. Compounds of formula LiₓNi_{α}Mn_{β}Co_{γ}M¹_{δ}M²ₘO_{2-z}M³_{z′} include, but are not limited to, Li_{1.2}Ni_{0.3}Mn_{0.6}O₂ LiMn_{0.5}O_{1.5} and LiNi_{1/3}Co_{1/3}Mn_{1/3}O₂ Li_{0.5}Ni_{0.25}Mn_{0.75}O₂.

Illustrative anodic materials of formula LiₓNi_{α}Mn_{β}Co_{γ}M¹_{δ}M²ₘO_{2-z}M³_{z′}, include, but are not limited to, LiMn_{0.5}O_{1.5}, LiNiO₂, LiCoO₂, LiNi_{1/3}Co_{1/3}Mn_{1/3}O₂ (NCM), LiNi_{0.8}Co_{0.05}A_{0.15}O₂ (NCA), Li_{0.5}Ni_{0.25}Mn_{0.75}O₂, or Li_{x′}Ni_{y′}Mn_{z′}Co_{1-z′}O_{2′}, where 0<x′, 0≦y′ and 0≦z′. In some embodiments where the anodic material is a compound of formula Li_{1+x′}Ni_{y′}Mn_{z′}Co_{1-z′}O₂, where 0<x′, 0≦y′ 1 and 0z′≦1.

The lithium oxides as anodic materials have a greater tap density and capacity than graphite-based electrodes. For example, graphite-based anodes typically have a tap density of about 1.1 g/ml, and a capacity of from about 250 mAh/g to about 300 mAh/g. In contrast, the anodic materials above exhibit a tap density of about 1.1 g/ml to about 3 g/ml, and a capacity of from about 300 mAh/g to about 1000 mAh/g. In some embodiments, the anodic materials above exhibit a tap density of about 1.5 g/ml to about 2.5 g/ml, and a capacity of from about 400 mAh/g to about 600 mAh/g. Additionally, the lithium oxides as anodic materials provide for an anode having an 80% increase in energy density, compared to typical graphite-based anodes.

The lithium metal oxides may, optionally, be coated with a metal-based material or metal oxide-based material. For example, illustrative metal-based or metal oxide materials may include, but are not limited to, one or more of Al₂O₃, AlF₃, ZrO₂, SiO₂, MgO, TiO₂, CaO, SnO₂, WO₃, In₂O₃, Ga₂O₃, Sc₂O₃, Y₂O₃, La₂O₃, HfO₂, V₂O₅, Nb₂O₅, Ta₂O₅, MnO, MnO₂, CoO, Co₂O₃, NiO, NiO₂, CuO, ZnO, MgF₂, CaF₂, Mo, Ta, W, Fe, Co, Cu, Ru, Pa, Pt, Al, Si, Sn, S, and Se. Alternatively, the lithium metal oxide may be, optionally, coated with carbon.

The anodic materials may be included in an anode as part of an electrochemical device. In addition to such an anode, the electrochemical devices may include a cathode and an electrolyte. With regard to the anode it may include any of the anodic materials as described above. The anode may also include a binder and other anodic additives, with the anodic material in contact with a current collector.

The current collector provides contact between the electroactive material and an external load to allow for the flow of electrons through a circuit to which the electrode is connected. The current collector may be a conductive material. Illustrative current collectors include, but are not limited to, aluminum, nickel, platinum, palladium, gold, silver, copper, iron, stainless steel, rhodium, manganese, vanadium, titanium, tungsten, or aluminum carbon coated or any carbon-coated metal described above.

The electrode may also contain a binder for retaining the electroactive materials, and any non-electroactive materials in contact with the current collector. Illustrative binders include, but are not limited to, polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, a copolymer of any two or more such polymers, or a blend of any two or more such polymers.

The electrodes may also contain a wide variety of other additives that are known in the art for use in electrodes. Illustrative additives include, but are not limited to, manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, or copper chloride.

The electrodes may also contain a conductive polymer. Illustrative conductive polymers include, but are not limited to, polyaniline, polypyrrole, poly(pyrrole-co-aniline), polyphenylene, polythiophene, polyacetylene, or polysiloxane.

In the electrochemical devices, the cathodic material may include a positive active material that is a spinel, a olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, L_{1+x″}Ni_{α}Mn_{β}Co_{γ}M⁵_{δ′}O_{2-z″}F_{z″}, Li₂MnO₃—LiₐM_{b}M′_{c}M″_{d}Oₑ, Li_{n′}B¹₂(M²O₄)₃ (Nasicon), silicates Li₂MSiO4 V₂O₅ or VO₂. The cathodic material may include a combination of any two or more such positive active materials. In those positive active materials, M⁴ may be Al, Mg, Ti, B, Ga, Si, Mn, or Co; M⁵ may be Mg, Zn, Al, Ga, B, Zr, or Ti; A is Li, Ag, Cu, Na, Mn, Fe, Co, Ni, Cu, or Zn; M, M′, M″ are transition metals, B¹ may be Ti, V, Cr, Fe, or Zr; M² is P, S, Si, W, or Mo; 0≦x′≦0.3; 0≦y≦0.5; 0≦z≦0.5; 0≦m≦0.5; 0≦n≦0.5; 0≦x″≦0.4; 0≦α≦1; 0≦β≦1; 0≦γ≦1; 0≦δ′≦0.4; 0≦z″≦0.4; and 0≦n′≦3; 0<a+b+c+d and 0<e. In some embodiments, 0<b+c+d and 0<e. In some embodiments, the positive active material may be a spinel, a olivine, or a carbon-coated olivine, as described in U.S. Pat. No. 7,632,137. For example, the spinel may be a spinel manganese oxide of formula of Li₁₊ₓMn_{2-z}M⁴_{y}O₄₋ₘX¹ₙ, wherein M⁴ is Al, Mg, Ti, B, Ga, Si, Ni, or Co; X¹ is S or F; 0≦x≦0.3; 0≦y≦0.5; 0≦z≦0.5; 0≦m≦0.5; and 0≦n≦0.5. Alternatively, the positive active material may include an olivine of formula of LiFe₁₋ₓM⁶_{y}PO₄₋ₘX¹ₙ, wherein M⁶ is Al, Mg, Ti, B, Ga, Si, Ni, Mn or Co; X¹ is S or F; 0≦x≦0.3; 0≦y≦0.5; 0≦z≦0.5; 0≦m≦0.5; and 0≦n≦0.5.

The cathode may also include a mixture of any two or more such positive active materials. As a non-limiting example, the cathode may include a blend of spinel and Li_{1+x″}Ni_{α}Mn_{β}Co_{γ}M⁵_{δ′}O_{2-z″}F_{z″}, where M⁵ is Mg, Zn, Al, Ga, B, Zr, or Ti; 0≦x″≦0.4; 0≦α≦1; 0≦β≦1; 0≦γ≦1; 0≦δ≦0.4; and 0≦z″≦0.4. The ratio of the spinel to the Li_{1+x″}Ni_{α}Mn_{β}Co_{γ}M⁵_{δ′}O_{2-z″}F_{z}, may be from about 0.5 wt % to about 98 wt %. As another non-limiting example, the cathode may include a blend of a olivine or a carbon-coated olivine and Li_{1+x″}Ni_{α}Mn_{β}Co_{γ}M⁵_{δ′}O_{2-z″}F_{z″}. The ratio of the olivine or carbon-coated olivine to the Li_{1+x″}Ni_{α}Mn_{β}Co_{γ}M⁵_{δ′}O_{2-z″}F_{z″} may be from about 0.5 wt % to about 98 wt %.

As noted above, the electrochemical devices include an electrolyte. The electrolyte includes at least a solvent and a salt. The electrolytes are typically non-aqueous, with the solvent typically being an aprotic solvent. Suitable solvents include, but are not limited to, carbonate-based solvents, oligo(ethyleneglycol)-based solvents, fluorinated oligomers, silanes, siloxanes, dimethoxyethane, triglyme, dimethylvinylene carbonate, organic phosphates, tetraethyleneglycol, dimethyl ether, polyethylene glycols, sulfones, sulfolane, and γ-butyrolactone. Illustrative carbonate-based solvents include those such as, but not limited to, dimethyl carbonate, ethyl methyl carbonate, diethyl carbonate, methyl propyl carbonate, ethyl propyl carbonate, dipropyl carbonate, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, or perfluorobutyl ethyl carbonate. Of course, the solvent may be a mixtures of any of the above solvents.

The salt of the electrolyte may be an alkali metal salt. In some embodiments, the alkali metal salt is a lithium salt. Illustrative salts for use in the electrolytes include, but are not limited to, LiBr, LiI, LiSCN, LiBF₄, LiAlF₄, LiPF₆, LiAsF₆, LiClO₄, Li₂SO₄, LiB(Ph)₄, LiAlO₂, Li[N(FSO₂)₂], Li[SO₃CH₃], Li[BF₃(C₂F₅)], Li[PF₃(CF₂CF₃)₃], Li[B(C₂O₄)₂], Li[B(C₂O₄)F₂], Li[PF₄(C₂O₄)], Li[PF₂(C₂O₄)₂], Li[CF₃CO₂], Li[C₂F₅CO₂], Li[N(CF₃SO₂)₂], Li[C(SO₂CF₃)₃], Li[N(C₂F₅SO₂)₂], Li[CF₃SO₃], Li₂B₁₂X₁₂₋ₙHₙ, Li₂B₁₀X²_{10-n′}H_{n′}, Li₂S_{x″}, (LiS_{x″}R¹)_{y}, (LiSe_{x″}R¹)_{y}, and lithium alkyl fluorophosphates; where X² is a halogen, n is an integer from 0 to 12, n′ is an integer from 0 to 10, x″ is an integer from 1 to 20, y is an integer from 1 to 3, and R¹ is H, alkyl, alkenyl, aryl, ether, F, CF₃, COCF₃, SO₂CF₃, or SO₂F. In some embodiments the salt includes Li[(C₂O₄)₂B], Li(C₂O₄)BF₂, LiClO₄, LiBF₄, LiAsF₆, LiPF₆, LiCF₃SO₃, Li(CF₃SO₂)₂N, Li(CF₃SO₂)₃C, LiN(SO₂C₂F₅)₂, or a lithium alkyl fluorophosphate.

In some embodiments, the electrolytes include an electrode stabilizing compound to protect the electrodes from degradation. The electrolytes may include an electrode stabilizing compound that can be reduced or polymerized on the surface of a negative electrode to form a passivation film on the surface of the negative electrode. The electrolytes may include an electrode stabilizing compound that can be oxidized or polymerized on the surface of the positive electrode to form a passivation film on the surface of the positive electrode. In some embodiments, electrolytes of the invention further include mixtures of the two types of electrode stabilizing compounds. The compounds are typically present in the electrolyte at a concentration of about 0.0001 wt % to about 10 wt %. In some embodiments, the compounds are present in the electrolyte at a concentration of about 0.0001 wt % to about 8 wt %. In some embodiments, the compounds are present in the electrolyte at a concentration of about 0.001 wt % to about 5 wt %. In some embodiments, the compounds are present in the electrolyte at a concentration of about 0.01 wt % to about 1 wt %.

In some embodiments, the electrode stabilizing compound is a linear, branched or cyclic hydrocarbon including at least one oxygen atom and at least one aryl, alkenyl or alkynyl group. A passivating film formed from such a electrode stabilizing compound may also be formed from a aryl compound or a heteroaryl compound where the compound comprises at least one oxygen atom. Alternatively, a combination of two compounds may be used. In some such embodiments, one compound is selective for forming a passivating film on the cathode to prevent leaching of metal ions and the other compound may be selective for passivating the anode surface to prevent or lessen the loss of metal ions from the anode.

Representative electrode stabilizing compounds include, but are not limited to, 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2 amino-3 vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2 vinyloxetane, 2-vinyloxy-cyclopropanone, 3-(N-vinylamino)cyclohexanone, 3,5-divinyl furoate, 3-vinylazetidin-2-one, 3 vinylaziridin 2 one, 3 vinylcyclobutanone, 3 vinylcyclopentanone, 3 vinyloxaziridine, 3 vinyloxetane, 3-vinylpyrrolidin-2-one, 4,4 divinyl-3 dioxolan 2-one, 4 vinyltetrahydropyran, 5-vinylpiperidin-3-one, allylglycidyl ether, butadiene monoxide, butyl vinyl ether, dihydropyran-3-one, divinyl butyl carbonate, divinyl carbonate, divinyl crotonate, divinyl ether, divinyl ethylene carbonate, divinyl ethylene silicate, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, vinyl ethylene silicate, vinyl ethylene sulfate, vinyl ethylene sulfite, vinyl methacrylate, vinyl phosphate, vinyl-2-furoate, vinylcylopropanone, vinylethylene oxide, or β-vinyl-γ-butyrolactone. Combinations of any two or more such compounds may also be used. In some embodiments the electrode stabilizing compound may include a cyclotriphosphazene that is substituted with F, alkyloxy, alkenyloxy, aryloxy, methoxy, allyloxy groups, or combinations of any two or more such compounds. For example, the compound may be a (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)-cyclotriphosphazene, (diaryloxy)(trifluoro)(methoxy)cyclotriphosphazene compounds, or a mixture of two or more such compounds. In some embodiments, the electrode stabilizing compound is vinyl ethylene carbonate, vinyl carbonate, or 1,2-diphenyl ether, or a mixture of any two or more such compounds.

Other representative electrode stabilizing compounds may include compounds with phenyl, naphthyl, anthracenyl, pyrrolyl, oxazolyl, furanyl, indolyl, carbazolyl, imidazolyl, or thiophenyl groups. For example, electrode stabilizing compounds include, but are not limited to, aryloxpyrrole, aryloxy ethylene sulfate, aryloxy pyrazine, aryloxy-carbazole trivinylphosphate, aryloxy-ethyl-2-furoate, aryloxy-o-terphenyl, aryloxy-pyridazine, butyl-aryloxy-ether, divinyl diphenyl ether, (tetrahydro-furan-2-yl)-vinylamine, divinyl methoxybipyridine, methoxy-4-vinylbiphenyl, vinyl methoxy carbazole, vinyl methoxy piperidine, vinyl methoxypyrazine, vinyl methyl carbonate-allylanisole, vinyl pyridazine, 1-divinylimidazole, 3-vinyltetrahydrofuran, divinyl furan, divinyl methoxy furan, divinylpyrazine, vinyl methoxy imidazole, vinylmethoxy pyrrole, vinyl-tetrahydrofuran, 2,4-divinyl isooxazole, 3,4 divinyl-1-methylpyrrole, aryloxyoxetane, aryloxy-phenyl carbonate, aryloxy-piperidine, aryloxy-tetrahydrofuran, 2-aryl-cyclopropanone, 2-diaryloxy-furoate, 4-allylanisole, aryloxy-carbazole, aryloxy-2-furoate, aryloxy-crotonate, aryloxy-cyclobutane, aryloxy-cyclopentanone, aryloxy-cyclopropanone, aryloxy-cyclolophosphazene, aryloxy-ethylene silicate, aryloxy-ethylene sulfate, aryloxy-ethylene sulfite, aryloxy-imidazole, aryloxy-methacrylate, aryloxy-phosphate, aryloxy-pyrrole, aryloxy-quinoline, diaryloxy-cyclotriphosphazene, diaryloxy ethylene carbonate, diaryloxy furan, diaryloxy methyl phosphate, diaryloxy-butyl carbonate, diaryloxy-crotonate, diaryloxy-diphenyl ether, diaryloxy-ethyl silicate, diaryloxy-ethylene silicate, diaryloxy-ethylene sulfate, diaryloxyethylene sulfite, diaryloxy-phenyl carbonate, diaryloxy-propylene carbonate, diphenyl carbonate, diphenyl diaryloxy silicate, diphenyl divinyl silicate, diphenyl ether, diphenyl silicate, divinyl methoxydiphenyl ether, divinyl phenyl carbonate, methoxycarbazole, or 2,4-dimethyl-6-hydroxy-pyrimidine, vinyl methoxyquinoline, pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o terphenyl, N-methylpyrrole, or naphthalene, or a mixture of any two or more such compounds.

In other embodiments, the electrode stabilizing compounds include spirocyclic hydrocarbons containing at least one oxygen atom and at least one alkenyl or alkynyl group. For example, such stabilizing compounds include those having Formula X:

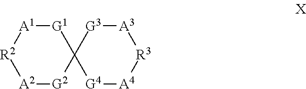

wherein A¹, A², A³, A⁴, G¹, G², G³, and G⁴ are independently O or CR⁴R⁵; provided that A¹ is not O when G¹ is O, A² is not O when G² is O, A³ is not O when G³ is O, and A⁴ is not O when G⁴ is O; R² and R³ are independently a divalent alkenyl or alkynyl group; and R⁴ and R⁵ at each occurrence are independently H, F, Cl, or an alkyl, alkenyl, or alkynyl group.

Representative examples of Formula X include, but are not limited to, 3,9-divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9 diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9 dimethylene-1,5,7,11-tetraoxaspiro[5.5]undecane, and 3,9 diethylidene-1,5,7,11-tetraoxaspiro[5.5]undecane. Furthermore, mixtures of any two or more electrode stabilizing compounds may also be used in the electrolytes.

The electrolyte may include an anion receptor which assists in the dissolution of LiF from an electrode surface. In some embodiments, the anion receptor is a Lewis acid. In other embodiments, the anion receptor is a borane, a boronate, a borate, a borole, or a mixture of any two or more such compounds. The anion receptor may be present at a concentration of about 0.0001 wt % to about 10 wt %. In some embodiments, the anion receptor may be present at a concentration of about 0.0001 wt % to about 5 wt %. In some embodiments, the anion receptor may be present at a concentration of about 0.0001 wt % to about 1 wt %. In some embodiments, the anion receptor may be present at a concentration of about 0.0001 wt % to about 0.08 wt %.

Illustrative anion receptors include, but not limited to, tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, 2-(2,4-difluorophenyl)-4-fluoro-1,3,2-benzodioxaborole, 2-(3-trifluoromethyl phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, and bis(1,1,1,3,3,3-hexafluoroisopropyl)pentafluorophenylboronate.

Lithium (chelato)borates such as Li[B(C₂O₄)₂] and Li(C₂O₄)BF₂, or lithium (chelato)phosphates such as LiPF₂(C₄O₈), listed above as salts for inclusion in the electrolytes, may also be used as an electrode stabilizing compound. As such embodiments, the salt is other than Li[B(C₂O₄)₂], Li[BF₂(C₂O₄)], Li[PF₄(C₂O₄)] or Li[PF₂(C₂O₄)₂]; and the electrolyte includes, as a electrode stabilizing compound, Li[B(C₂O₄)₂], Li[BF₂(C₂O₄)], Li[PF₄(C₂O₄)], Li[PF₂(C₂O₄)₂], or a mixture of two or more such materials. In some other embodiments, the lithium salt is other than Li₂B₁₂X²₁₂₋ₙHₙ, or Li₂B₁₀X²_{10-n′}H_{n′}; and the electrolyte includes as a electrolyte compound, Li₂B₁₂X²₁₂₋ₙHₙ, Li₂B₁₀X²_{10-n′}H_{n′}, or a mixture of two or more of such compounds. In such compounds, X² is OH, OCH₃, F, Cl, Br, or I, n is an integer from 0 to 12, and n′ is an integer from 0 to 10. Such electrode stabilizing compounds may be present from about 0.0001 wt % to about 10 wt %. In some embodiments, the electrode stabilizing compounds may be present from about 0.001 wt % to about 8 wt %. In some embodiments, the electrode stabilizing compounds may be present from about 0.001 wt % to about 5 wt %. In some embodiments, the electrode stabilizing compounds may be present from about 0.001 wt % to about 1 wt %.

In some embodiments, the electrolyte of the electrochemical device includes a lithium salt other than Li[(C₂O₄)₂B] or Li(C₂O₄)BF₂; a polar aprotic solvent; a first electrode stabilizing compound at a concentration of 0.001 wt % to about 8 wt %, wherein the first electrode stabilizing compound is an anion receptor that assists in the dissolution of LiF on the surface of electrode; and a second electrode stabilizing compound that is Li[(C₂O₄)₂B], Li(C₂O₄)BF₂, or a mixture thereof from about 0.001 wt % to about 8 wt % of an electrode stabilizing compound.

### EXAMPLES

### Example 1

Preparation of an anodic material of Li_{1.2}Ni_{0.3}Mn_{0.6}O₂. Li_{1.2}Ni_{0.3}Mn_{0.6}O₂ was prepared by heating to 900° C. for 12 hours a mixture of Ni_{0.3}Mn_{0.6}CO₃ and Li₂CO₃ carbonate. The Ni_{0.3}Mn_{0.6}CO₃ was previously prepared from nickel sulfate, manganese sulfate, and sodium carbonate.

### Example 2

Preparation of an anode with Li_{1.2}Ni_{0.3}Mn_{0.6}O_{2.1}. The Li_{1.2}Ni_{0.3}Mn_{0.6}O₂ (80 wt %) was slurried with acetylene black (10 wt %) and polyimide binder (10 wt %) in N-methylpyrrolidone (NMP), and the slurry was applied to a current collector. The NMP was then removed by placing the slurry and current collector in a 200° C. oven for 3 hours.

### Example 3

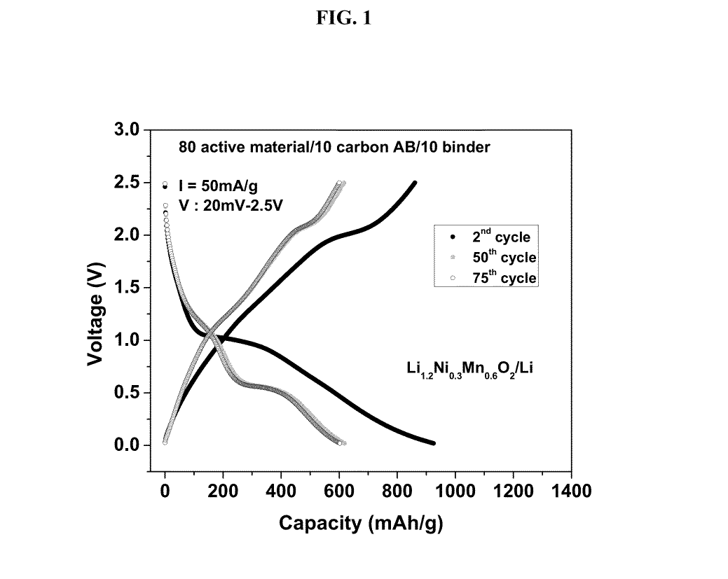

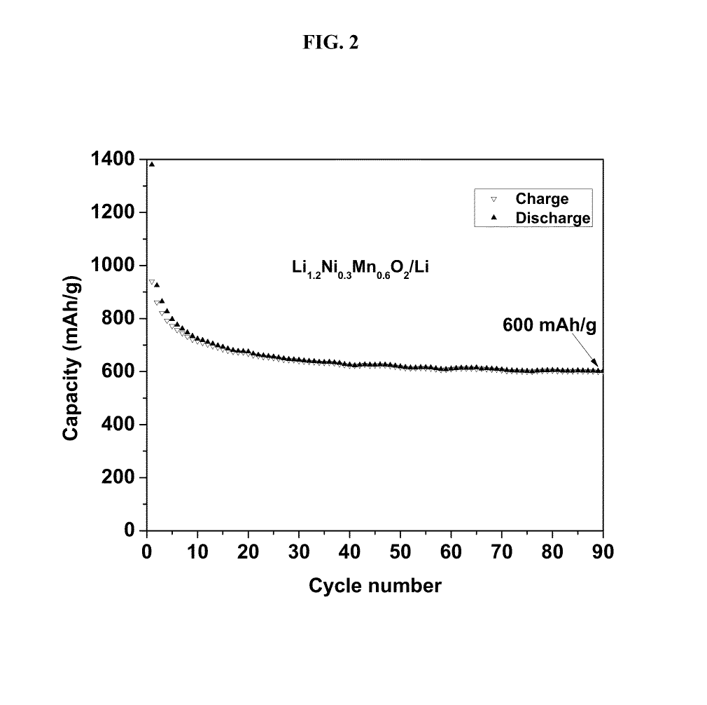

Testing of the anode with Li_{1.2}Ni_{0.3}Mn_{0.6}O₂. The anode prepare with the Li_{1.2}Ni_{0.3}Mn_{0.6}O₂ was tested in lithium half-cell using 2325 coin cell batteries between 20 my and 2.5 V using 1.2M LiPF₆ in 3:7 ethylene carbonate:ethylmethylcarbonate electrolyte It was observed that the Li_{1.2}Ni_{0.3}Mn_{0.6}O₂ delivers more than 600 mAh/g capacity after 90 cycles with outstanding cycleability (see FIGS. 1 and 2). These figures demonstrate that lithium insertion is reversible. Furthermore, after the 20^{th} cycle, a charge discharge coulombic efficiency of about 100% was observed for this material.

### Example 4

Preparation of an anode of LiNi_{1/3}Co_{1/3}Mn_{1/3}O₂. The LiNi_{1/3}Co_{1/3}Mn_{1/3}O₂ material was prepared by heating for 12 hours at 900° C. a mixture of Ni_{1/3}Co_{1/3}Mn_{1/3}CO₃ and Li₂CO₃ carbonates. Ni_{1/3}Co_{1/3}Mn_{1/3}CO₃ was already prepared from nickel sulfate, cobalt sulfate, manganese sulfate, and sodium carbonate.

### Example 5

Preparation of an anode with LiNi_{1/3}Co_{1/3}Mn_{1/3}O₂. An anode laminate was prepared by preparing a slurry of LiNi_{1/3}Co_{1/3}Mn_{1/3}O₂ (80 wt %), acetylene black (10 wt %) and polyvinyldifluoride (PVDF, 10 wt %) in NMP. The NMP was then removed by placing the slurry and current collector in a 200° C. oven for 3 hours.

### Example 6

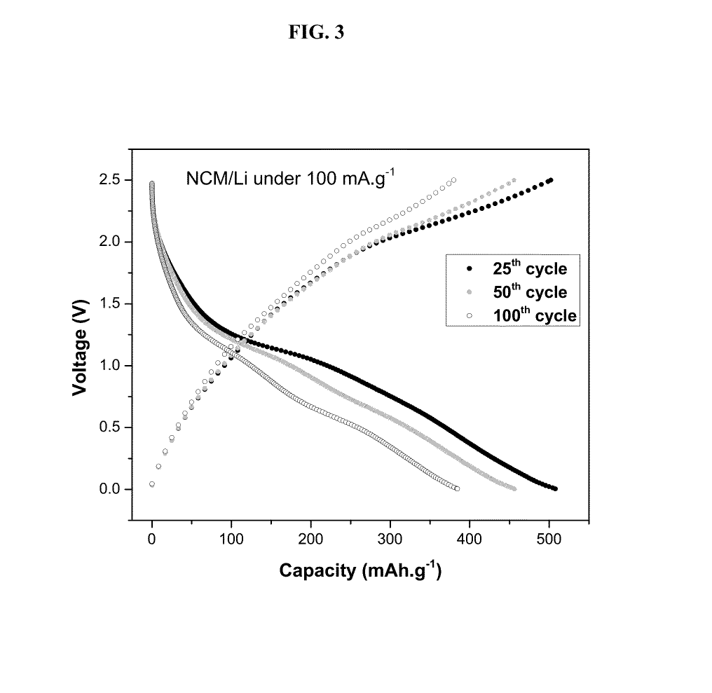

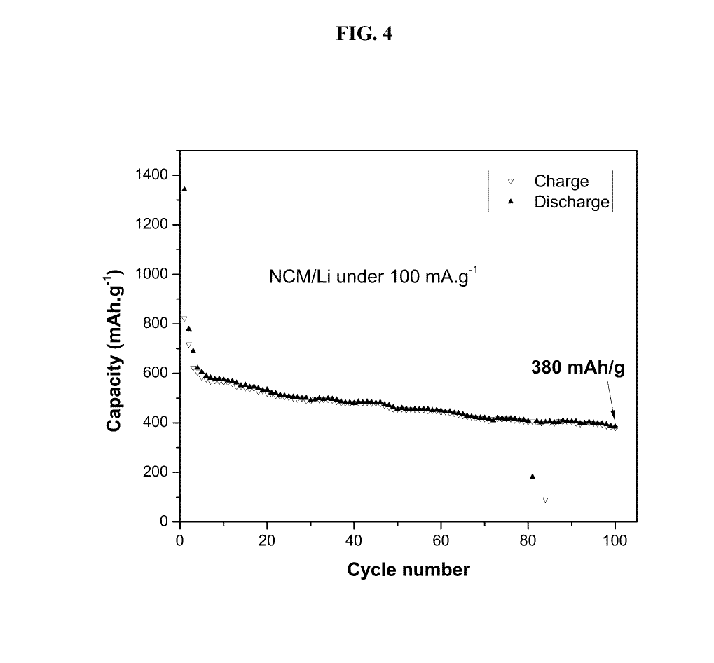

Testing of the anode with LiNi_{1/3}Co_{1/3}Mn_{1/3}O₂. The LiNi_{1/3}Co_{1/3}Mn_{1/3}O₂ anode was tested in lithium half-cell using 2325 coin cell batteries between 20 my and 2.5V using 1.2M LiPF6 in (3EC/7EMC) electrolyte. It was observed that Li_{1.2}Ni_{0.3}Mn_{0.6}O₂ delivers more than 380 mAh/g capacity after 100 cycles with outstanding cycleability (see FIGS. 3 and 4). After the 5^{th} cycle a charge discharge coulombic efficiency of about 100% was observed for this material.

### Example 7

Preparation of an anode of LiNi_{0.8}Co_{0.15}Al_{0.05}O₂. The LiNi_{0.8}Co_{0.15}Al_{0.05}O₂ material was prepared by heating for 12 hours 900° C. a mixture of Ni_{0.8}Co_{0.15}Al_{0.05}(OH)₂ and LiOH.

### Example 8

Preparation of an anode with LiNi_{0.8}Co_{0.15}Al_{0.05}O₂. An anode laminate was prepared by preparing a slurry of LiNi_{0.8}Co_{0.15}Al_{0.05}O₂ (80 wt %), acetylene black (10 wt %) and polyvinyldifluoride (PVDF, 10 wt %) in NMP. The NMP was then removed by placing the slurry and current collector in a 75° C. oven for 6 hours.

### Example 9

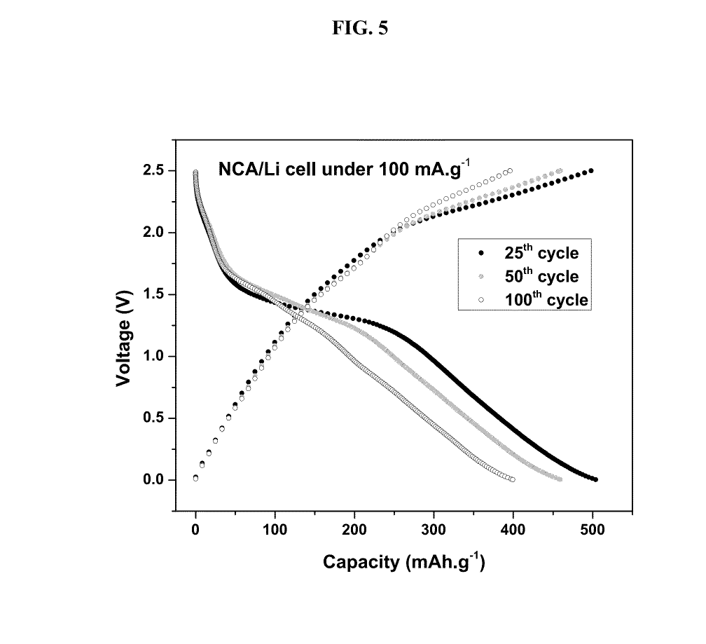

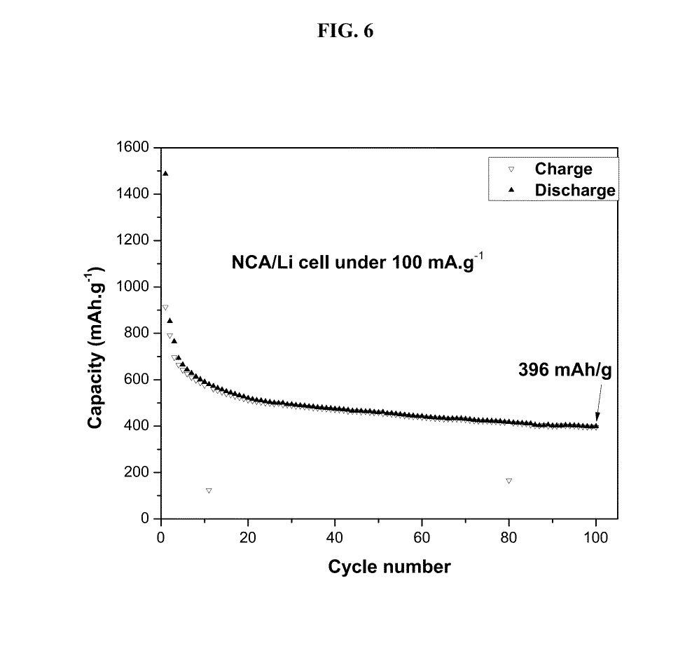

Testing of the anode with LiNi_{0.8}Co_{0.15}Al_{0.05}O₂. The LiNi_{0.8}Co_{0.15}Al_{0.05}O₂ Anode was tested in lithium half-cell using 2325 coin cell batteries between 20 my and 2.5V. using 1.2M LiPF6 in (3EC/7EMC) electrolyte. It was observed that LiNi_{0.8}Co_{0.15}Al_{0.05}O₂ delivers more than 396 mAh/g capacity after 100 cycles with outstanding cycleability (see FIGS. 5 and 6). After the 5^{th} cycle a charge discharge coulombic efficiency of about 100% was observed for this material.

### Example 10

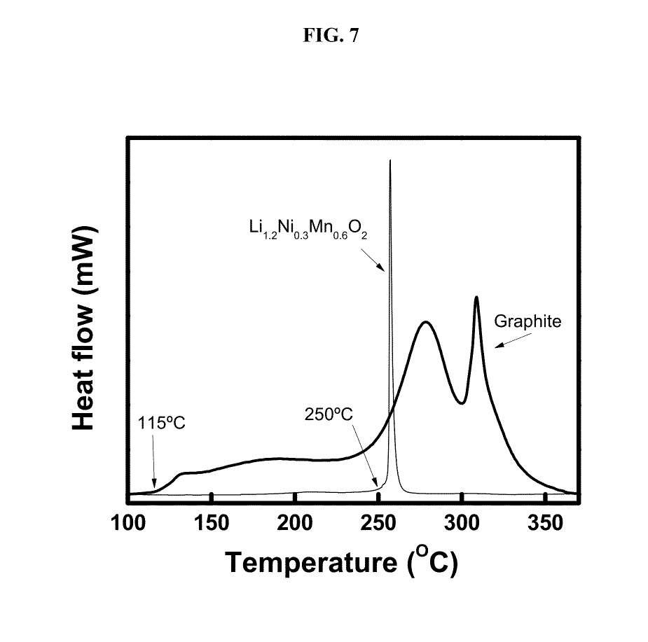

Thermal stability. The thermal stability of a fully discharged anode material is an important factor in batteries safety performance. Graphite is known to be less safe as the thermal runaway start at about 115° C. as illustrated in FIG. 7. The heat generated from the reaction of Li_{1.2}Ni_{0.3}Mn_{0.6}O₂ with a lithium electrolyte is limited, as illustrated by the small exothermic peak observed in FIG. 7 at 259° C. For the oxide material, the thermal runaway starts at 250° C., nearly twice the temperature as for graphite.

### EQUIVALENTS

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

While exemplary embodiments are described herein, it should be understood that changes and modifications can be made therein in accordance with ordinary skill in the art without departing from the invention in its broader aspects as defined in the following claims.

1. An electrochemical device comprising:
an electrolyte;
a cathode; and
an anode comprising a negative active material of Formula
LiₓNi_{α}Mn_{β}Co_{γ}M¹_{δ}M²ₘO_{2-z}M³_{z′};
wherein:
M¹ is Mg, Zn, Al, Ga, B, Zr, Ti, V, Cr Ag, Cu, Na, Mn, Fe, Cu, or Zr;
M² is P, S, Si, W, or Mo;
M³ is F, Cl and N;
0<x; 0≦α≦1; 0≦β≦1; 0≦γ≦1; 0≦δ≦1; 0≦m≦0.5; 0≦z≦0.5; and 0≦z′≦0.5;
with the proviso that at least one of α, β, and γ is greater than 0.

2. The electrochemical device of claim 1, wherein x is 0.5 or 1; m=0; z′=0; M¹ is B, Al, or Ga; and 0≦δ≦0.25.

3. The electrochemical device of claim 1, wherein the negative active material comprises LiMn_{0.5}O_{1.5}, LiNiO₂, LiCoO₂, LiNi_{1/3}Co_{1/3}Mn_{1/3}O₂, LiNi_{0.8}Co_{0.05}Al_{0.15}O₂, or Li_{0.5}Ni_{0.25}Mn_{0.75}O₂.

4. The electrochemical device of claim 1, wherein the negative active material is a compound of Formula Li_{1+x′}Ni_{y′}Mn_{z″}Co_{1-z″}O₂; 0≦x′; 0≦y′; and 0≦z″.

5. The electrochemical device of claim 1, wherein the anode comprises a plurality of particles of the negative active material.

6. The electrochemical device of claim 5, wherein the plurality of particles is at least partially coated with a material comprising Al₂O₃, AlF₃, ZrO₂, SiO₂, MgO, TiO₂, CaO, SnO₂, WO₃, In₂O₃, Ga₂O₃, Sc₂O₃, Y₂O₃, La₂O₃, HfO₂, V₂O₅, Nb₂O₅, Ta₂O₅, MnO, MnO₂, CoO, Co₂O₃, NiO, NiO₂, CuO, ZnO, MgF₂, CaF₂, Mo, Ta, W, Fe, Co, Cu, Ru, Pa, Pt, Al, Si, Sn, S, or Se.

7. The electrochemical device of claim 5, wherein the plurality of particles is at least partially coated with carbon.

8. The electrochemical device of claim 1, wherein the cathode comprises a positive active material comprising a spinel, a olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, Li_{1+x″}Ni_{α}Mn_{β}Co_{γ}M⁵_{δ′}O_{2-z″}F_{z″}, A_{n′}B¹₂(M²O₄)₃, or VO₂;
wherein:
M⁴ is Al, Mg, Ti, B, Ga, Si, Mn, or Co;
M⁵ is Mg, Zn, Al, Ga, B, Zr, or Ti;
A is Li, Ag, Cu, Na, Mn, Fe, Co, Ni, Cu, or Zn;
B¹ is Ti, V, Cr, Fe, or Zr;
0≦x≦0.3; 0y≦0.5; 0≦z≦0.5; 0≦m≦0.5; 0≦n≦0.5; 0≦x″≦0.4; 0≦α≦1; 0≦β≦1; 0≦γ≦1; 0≦δ′≦0.4; 0≦z″≦0.4; and 0≦n′≦3; with the proviso that at least one of α, β and γ is greater than 0.

9. The electrochemical device of claim 1, wherein the cathode comprises a spinel, a olivine, or a carbon-coated olivine.

10. The electrochemical device of claim 1, wherein the cathode comprises a spinel of Formula Li₁₊ₓMn_{2-z}M⁶_{y}O₄₋ₘX′n, wherein M⁶ is Al, Mg, Ti, B, Ga, Si, Ni, or Co; X′ is S or F; and wherein 0≦x≦0.3; 0≦y≦0.5; 0≦z≦0.5; 0≦m≦0.5; 0≦n≦0.5.

11. The electrochemical device of claim 1, wherein the cathode comprises a olivine of Formula of LiFe_{1-z}M⁶_{y}PO₄₋ₘX¹ₙ, wherein M⁶ is Al, Mg, Ti, B, Ga, Si, Ni, Mn or Co; X¹ is S or F; and 0≦x≦0.3; 0≦y≦0.5; 0≦z≦0.5; 0≦m≦0.5; and 0≦n≦0.5.

12. The electrochemical device of claim 10, wherein the cathode comprises a blend of the spinel and a positive active material of Formula Li_{1+x″}Ni_{α}Mn_{β}Co_{γ}M⁵_{6′}O_{2-z″}F_{z″}; M⁵ is Mg, Zn, Al, Ga, B, Zr, or Ti; 0≦x″≦0.4; 0≦α≦1; 0≦β≦1; 0≦γ≦1; 0≦δ′≦0.4; and 0≦z″≦0.4.

13. The electrochemical device of claim 12, wherein a ratio of the spinel to Li_{1+x″}Ni_{α}Mn_{β}Co_{γ}M⁵_{δ′}O_{2-z″}F_{z″} is from about 0.5 wt % to about 98 wt %.

14. The electrochemical device of claim 11, wherein the cathode comprises a blend of the olivine or a carbon-coated olivine and Li_{1+x″}Ni_{α}Mn_{β}Co_{γ}M⁵_{δ′}O_{2-z″}F_{z″}; M⁵ is Mg, Zn, Al, Ga, B, Zr, or Ti; 0≦x″≦0.4; 0≦α≦1; 0≦β≦1; 0≦γ≦1; 0≦δ′≦0.4; and 0≦z″≦0.4.

15. The electrochemical device of claim 14, wherein a ratio of the olivine or carbon-coated olivine to Li_{1+x″}Ni_{α}Mn_{β}Co_{γ}M⁵_{δ′}O_{2-z″}F_{z″} is from about 0.5 wt % to about 98 wt %.

16. The electrochemical device of claim 1, wherein the electrolyte comprises an aprotic solvent and a salt.

17. The electrochemical device of claim 16, wherein the aprotic solvent comprises a silane, a siloxane, an organic phosphate, ethylene carbonate, propylene carbonate, dimethyl carbonate, diethyl carbonate, ethyl methyl carbonate, dimethyl ether, or gamma butyrolactone.

18. The electrochemical device of claim 16, wherein the salt comprises LiBr, LiI, LiSCN, LiBF₄, LiAlF₄, LiPF₆, LiAsF₆, LiClO₄, Li₂SO₄, LiB(Ph)₄, LiAlO₂, Li[N(FSO₂)₂], Li[SO₃CH₃], Li[BF₃(C₂F₅)], Li[PF₃(CF₂CF₃)₃], Li[B(C₂O₄)₂], Li[B(C₂O₄)F₂], Li[PF₄(C₂O₄)], Li[PF₂(C₂O₄)₂], Li[CF₃CO₂], Li[C₂F₅CO₂], Li[N(CF₃SO₂)₂], Li[C(SO₂CF₃)₃], Li[N(C₂F₅SO₂)₂], Li[CF₃SO₃], Li₂B₁₂X₁₂₋ₙHₙ, Li₂B₁₀X²_{10-n′}H_{n′}, Li₂S_{x″}, (LiSₓ—R¹)_{y}, (LiSe_{x″}—R¹)_{y}, and lithium alkyl fluorophosphates; where X² is a halogen, n is an integer from 0 to 12, n′ is an integer from 0 to 10, x″ is an integer from 1 to 20, y is an integer from 1 to 3, and R¹ is H, alkyl, alkenyl, aryl, ether, F, CF₃, COCF₃, SO₂CF₃, or SO₂F.

19. The electrochemical device of claim 16, wherein the electrolyte further comprises tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, 2-(2,4-difluorophenyl)-4-fluoro-1,3,2-benzodioxaborole, 2-(3-trifluoromethyl phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, or bis(1,1,1,3,3,3-hexafluoroisopropyl)pentafluorophenylboronate.

20. The electrochemical device of claim 16, wherein the salt is other than Li[B(C₂O₄)₂] or Li[BF₂(C₂O₄)], and the electrolyte comprises about 0.001 to about 8 wt % Li[(C₂O₄)₂B], Li(C₂O₄)BF₂, or a mixture thereof.

21. The electrochemical device of claim 1 further comprising a first electrode stabilizing compound configured to be reduced or polymerized on the surface of the anode to form a passivation film on the surface of the anode.

22. The electrochemical device of claim 1 further comprising a second electrode stabilizing compound configured to be oxidized or polymerized on the surface of the cathode electrode to form a passivation film on the surface of the cathode.
